(19) United States
(12) Patent Application Publication
(10) Pub. No.: US 2026/0260193 A1
(43) Pub. Date: Sep. 3, 2026

(54) WORK OBJECTS AND ASSOCIATED WORK OBJECT CHANNELS IN A COMMUNICATION PLATFORM

(71) Applicant: Salesforce, Inc., San Francisco, CA (US)

(72) Inventors: Kevin Marshall, Mill Valley, CA (US); Josef Teplow, New York, NY (US)

(21) Appl. No.: 19/068,307

(22) Filed: Mar. 3, 2025

(51) Int. Cl. G06Q 10/0631; G06Q 10/1093

(52) U.S. Cl. CPC G06Q 10/06316; G06Q 10/1097

(57) ABSTRACT

Techniques for generating work objects are discussed herein. In some examples, a user may request to generate a work object. A requesting user may specify work object metadata that satisfies a schema associated with the communication platform. The communication platform may generate a recommendation including a confidence level indicative of whether the work object is likely to be coherently associated with the one or more ongoing conversations. The communication platform may display the recommendation to the requesting user. Accordingly, the communication platform may generate the work object and/or work object based at least in part on the work object metadata and the schema associated with the communication platform.

### TECHNICAL FIELD

Communication platforms are becoming increasingly more popular for organizations to facilitate work related communications. Users of such communication platforms can communicate with other users via video conferencing, channels, direct messages, boards, and/or any other type of virtual space associated with the communication platform. In some examples, users may utilize multiple such virtual spaces to continue an ongoing conversation, or to otherwise facilitate related conversations. For instance, existing techniques can require users to scroll and/or otherwise navigate numerous virtual spaces to understand context of a particular communication before participating in an ongoing conversation. However, navigating disparate and/or disjointed conversations in order to effectively utilize a communication platform is inefficient and can be overwhelming, resulting in poor user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2A illustrates a user interface for a group-based communication system having a work object rendered therein, for certain examples.

FIG. 2B illustrates a user interface for a group-based communication system having the work object of FIG. 2A and an associated work object channel rendered therein, for certain examples.

FIG. 3 illustrates a pictorial flow diagram of an example process for emitting typed metadata into a communication platform, for certain examples.

FIG. 4 illustrates a sequence diagram of an example process for requesting to create a work object according to a work object schema, determining a recommendation based on the request, receiving user input data based on the recommendation, and determining whether to generate the work object based on the recommendation.

FIG. 5 is a flow diagram illustrating an example process of receiving a request to generate a work object, identifying work object metadata associated with the request, determining that the work object metadata satisfies a work object schema, and generating the work object based on the work object metadata and the work object schema.

### DETAILED DESCRIPTION

As described above, conventional techniques for facilitating communication within a communication platform may be suboptimal, requiring users to spend excessive amounts of time navigating virtual spaces of the communication platform in order to effectively participate in related conversations.

Techniques for identifying and generating work objects and/or generating work object channels associated with such work objects are discussed herein. In examples, a work object may comprise a container (e.g., a software package) for events occurring within or facilitated by a communication platform. An event may be a set of rules, operations, processes, steps, sub-steps, or the like that result in execution of an action (e.g., a task, an approval, an email, a call, etc.). In examples, a work object associated with a task event (referred to herein as a “task” work object) may comprise a set of rules that result in execution of one or more actionable steps to be undertaken (e.g., one or more duties to be performed by one or more roles). An example work object associated with an approval event (e.g., an “approval” work object) may comprise a set of rules that result in execution of one or more consent actions, agreement actions, sanction actions, endorsement actions, or the like. An example work object associated with an email event (e.g., an “email” work object) may comprise a set of rules that result in execution of one or more email creation, modification, or transmission actions. It will be understood that the foregoing enumeration of work object types is merely exemplary and not intended to be limiting. As described herein, a communication platform may determine whether to generate a work object and a work object channel and/or how to render the generated work object and work object channel based on whether underlying work object metadata adheres to one or more schemas (also referred to herein as “work object schemas”) associated with the communication platform. A schema of various examples may define or otherwise describe a standard format according to which work object metadata is structured and organized. That is, in various examples, the communication platform may utilize one or more schemas to define the elements (or fields) that comprise metadata associated with work objects. Accordingly, a “task” work object of various examples can produce the requisite metadata fields to implement a task event (or functionality) within or in association with the communication platform. An “approval” work object of various examples can produce the requisite metadata fields to implement an approval event (or functionality) within or in association with the communication platform. An “email” work object of various examples can produce the requisite metadata fields to implement an email event (or functionality) within or in association with the communication platform. A “call” work object of various examples can produce the requisite metadata fields to implement a call event (or functionality) within or in association with the communication platform.

In some examples, a user may request, via a virtual space associated with the communication platform (e.g., a calendar service, a scheduling service, a channel, a board, a direct message, etc.), to generate a work object. That is, when a user composes, posts, shares, or otherwise submits a fully qualifying work object within the virtual space (e.g., requests to generate the work object), the user may specify a schema (e.g., one or more standardized structures, types, formats, and/or attributes) associated with the work object that is indicative of a format in which the work object and/or the work object channel should be rendered. In some instances, a format in which the work object and/or the work object channel should be rendered may be based at least in part on a context in which the work object is referenced.

Based on receiving the request from the user, the communication platform may determine whether and/or how the work object or the work object channel is to be rendered by determining whether there is sufficient and/or appropriate data to satisfy the specified schema. Further, the communication platform may determine a likelihood that the to-be-generated work object is contextually related to one or more other communications within the communication platform. In such instances, the communication platform may generate a recommendation including a confidence level indicative of whether the work object and/or the work object channel are likely to be rendered appropriately. In such cases, the communication platform may display the recommendation to the user. In response to displaying the recommendation, the communication platform may receive user input data from the user that may indicate an intent of the user to generate the work object and/or the work object channel. Accordingly, the communication platform may generate the work object and/or the work object channel based on the received user input data. Alternatively, in some cases, the communication platform may determine whether to generate and/or how to render the work object or the work object channel based on a default setting associated with the communication platform. For instance, the communication platform of some examples may only generate or render work object channels associated with authenticated work objects. That is, in some cases, the communication platform may refrain from generating and/or rendering work objects prior to receiving user authentication input. In still some other cases, the communication platform may generate and/or publish a work object within a virtual space, but may refrain from unfurling the work object prior to receiving the user authentication input. As discussed throughout this disclosure, the techniques presented herein may improve user experience by enabling users to effectively participate in related conversations without having to interact with large amounts data exchanged via the communication platform—e.g., without extensive scrolling or navigation of the communication platform (such as navigating various channels, direct messages, threads, etc. to understand the context of a message).

To address the above noted technical problems and other inefficiencies, the systems and/or techniques described herein may include a conversation optimizing system (which also may be referred to as a “conversation optimizing component”) configured to determine whether and/or how to generate a work object and/or how to render an associated work object channel based at least in part on determining that the work object (e.g., work object metadata) satisfies a schema associated with the communication platform. The technical solutions discussed herein therefore solve one or more technical problems associated with conventional communication techniques that result in suboptimal and/or inefficient user participation in conversations.

Initially, the communication platform may receive, from a user profile of a requesting user, a request to generate a work object and/or an associated work object channel. In some examples, the communication platform can be a group-based communication platform, a channel-based messaging platform, a sales-based platform, an email-based platform, a calendar-based platform, and/or any other platform for facilitating communication between and among users. Users can use a variety of devices (or “user devices”) to access the communication platform. Such devices may include any suitable type of computing device, e.g., portable, semi-portable, semi-stationary, or stationary. Some examples of a user device can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein.

In some instances, the requesting user can use a device (or user device) to submit, from the user profile of the requesting user, a request to generate a work object. That is, the requesting user may compose and submit, post, publish, or the like, within a virtual space of the communication platform, a message that comprises a qualifying work object. For the purpose of this discussion, a work object can comprise text, an image, a video, a snippet of content, a user profile, a thread, a file, a channel, a direct message, a board, a virtual space, an invitation (e.g., a calendar invitation, an event request, etc.), a sign-in request, a workflow, an application, and/or any other data item. A requesting user may be any user (e.g., administrative user, managing user, and/or any other user type) that creates and submits the qualifying work object. When creating the work object, the requesting user may populate or otherwise specify one or more metadata fields associated with a predefined schema used by the communication platform to define and/or structure work objects according to the metadata. Such metadata fields may include an identifier field (e.g., a file name, a username/identifier, an organization name/identifier, etc.), a description field (e.g., a title, an author, purpose), creation date, start time and/or date (e.g., Jan. 1, 2024 at 3:00 PM)), end time and/or date, duration (e.g., 1 hour, 2 hours, etc.), keyword(s), etc.), an administration field (e.g., one or more roles (or user profile roles) or role types that are required by the work object, documents or files (e.g., attachments) associated with the work object (e.g., to be reviewed, discussed, or referenced, etc.), event title, and/or any other type of data.

As discussed throughout, a communication platform may utilize metadata associated with a work object to conform to one or more predefined schemas associated with the communication platform. For instance, the one or more schemas may be “strongly typed.” In such cases, the communication platform may explicitly define the metadata fields (and/or the allowed data types for each metadata field) that correspond to a particular schema. A schema may thus be satisfied based on the data input to each prerequisite metadata field associated with a work object. When a work object is included in a message submitted to the communication platform, the communication platform may determine whether a predefined schema is satisfied. As just one example, when composing a message comprising a work object, the requesting user may indicate intent for the work object to be generated and/or rendered as a “task” work object. That is, the requesting user may create, via the communication platform, an object representing a real world action to be done or undertaken. The “task” work object may contain members, attributes and/or properties (e.g., name, description, priority, due date, status, etc.) as well as methods defining the “task” work object's behavior (e.g., actionable steps or sub-steps to be taken to complete the task such as to “identify,” “locate,” “summarize,” “sign,” etc.). Accordingly, the requesting user of the foregoing example may “hydrate” the work object by specifying in a corresponding metadata field that a required role for the underlying task is, for instance, a sales representative. Additionally, the requesting user may specify in a corresponding metadata field that an action assigned to the required role may be that the sales representative closes a specific deal (e.g., as accomplished by the sales representative signing a specific contract, etc.) Accordingly, upon determining that the request comprises sufficient metadata to satisfy the “task” schema, the communication platform may also determine that there is sufficient metadata to generate the work object and/or the work object channel.

Based on receiving the request to generate and/or render the work object from the requesting user profile, the communication platform may determine whether the work object is predicted to be relevant to one or more ongoing conversations based at least in part on the underlying metadata. That is, the communication platform may analyze the metadata to determine whether there is a sufficient amount (e.g., a threshold amount) of metadata contained in the work object (such as identified usernames, real names, email addresses, conversation topics, etc.) that is coherently associated with a known topic, channel, direct message, thread, or the like. In some examples, this determination is based on embeddings. For instance, the communication platform may generate one or more tokens based on the metadata. The communication platform may further determine embeddings (based on the generated one or more tokens) that indicate semantic relationships between the one or more tokens. A similarity between token embeddings may indicate a semantic similarity such as how commonly tokens are used together or in similar contexts with one another. In some cases, a semantic similarity is represented as the Cosine similarity between embeddings. As such, the communication platform may identify, access, receive, or otherwise retrieve conversation data determined to be coherently associated with and/or semantically similar to the work object (e.g., the underlying metadata). That is, the communication platform may analyze conversation data stored with and/or mapped to the work object to determine if a work object may pertain to a known conversation.

In some examples, the communication platform may generate a recommendation that indicates the predicted context for the requested work object. For example, if the communication platform determines that all (or a threshold amount) of the underlying metadata (e.g., roles, conditions, objectives/goals, etc.) contained in the work object is coherently associated with a known topic, channel, direct message, thread or the like, the communication platform may generate a recommendation that indicates a high likelihood of the work object pertaining to an ongoing conversation. In such cases, the communication platform may identify the ongoing conversation(s) to which the work object pertains by reference in the recommendation—for example by referencing one or more unique conversation identifiers associated with the pertinent ongoing conversation(s). Otherwise, if the communication platform determines that less than a threshold amount of the underlying metadata contained in the work object is coherently associated with a known topic, channel, direct message or the like, then the communication platform may generate a recommendation that indicates a moderate to low likelihood of the work object pertaining to an ongoing conversation. In any case, the communication platform may determine, (such as based on historical data, context or any other metric), one or more visual arrangements or “layouts” of elements in the work object to include in the recommendation. For instance, the communication platform may determine, based on the work object satisfying a schema associated with the communication platform, one or more affordances or affordance types configured to indicate to users how to best interact with a generated and rendered work object. As just one non-limiting but illustrative example, the communication platform may determine (e.g., based on the above example wherein the communication platform identified the work object as satisfying a “task” schema) one or more task-type affordances to recommend including, but not limited to, checkboxes, progress indicators (e.g., progress bars, percentage indicators, or the like), drag-and-drop functionality (e.g., to allow users to reorder or otherwise prioritize action items) or the like. Alternatively or additionally, the recommendation generated by the communication platform may include one or more suggestions (e.g., a suggestion to refer to a known internal project code, a suggestion to @-mention a particular user, a suggestion to require users to authenticate in order to access or otherwise view data associated with a work object, etc.) that may lead to users of the communication platform being able to more effectively retrieve and navigate communications related to the work object.

In some examples, the communication platform may cause the recommendation to be displayed via a user interface of the requesting user profile. The communication platform may display or otherwise render the recommendation to the virtual space within which the requesting user profile submitted the request. However, that is not intended to be limiting; in other examples, the recommendation may be displayed to any other virtual space in the communication platform. That is, the recommendation may be displayed as a separate interface such as an overlay interface, a pop-up box, and/or any other type of interface. In some examples, the recommendation may be actionable to enable a requesting user to cancel the request, confirm the request (e.g., instruct the communication platform to generate the work object and/or the work object channel), and/or modify the request (e.g., modify the schema and/or the underlying metadata) such that the predicted level of coherent association between the work object and an ongoing conversation increases.

In some examples, the communication platform may receive user input data in response to displaying the recommendation. User input data may include any type of input (e.g., audio data (e.g., voice command), physical input (e.g., touch), etc.) provided by a user profile (e.g., the requesting user profile). As indicated above, the user input data may include a request (or intent) to cancel the work object (e.g., the requesting user profile may determine that it may be beneficial to not generate the work object because the recommendation indicated that the work object is predicted to not be associated with any ongoing conversation), a request (or intent) to confirm the work object, or a request to modify the work object (e.g., the schema or metadata underlying the work object). If the user input data includes a request to cancel the work object, the communication platform may cancel the request and ensure that the work object is not get generated and/or does not become associated with any users, conversations, and/or virtual spaces. If the user input data includes a request to confirm the work object, the communication platform may generate the work object and associate the work object with the listed (or identified) user profiles, conversations, and/or virtual space(s) (such as the virtual space in which the request comprising the work object was composed and/or submitted). If the user input data includes a request to modify the work object, the communication platform may re-evaluate the work object based on the modified metadata (e.g., to determine that the work object now satisfies a new schema) and generate an updated recommendation according to the modified metadata. Alternatively or additionally, the communication platform may generate a new work object based on the modified metadata.

Additionally or alternatively, while the techniques above describe performing such conversation optimization techniques based on metadata associated with work objects as provided by a requesting user profile, in other examples, a requesting user profile may provide an intended purpose or description for a work object and submit such data to the communication platform which may then determine whether such a work object pertains to an ongoing conversation based on analyzing historical data (e.g., conversation historical data). That is, instead of the requesting user profile populating one or more metadata fields, the requesting user profile may provide a description of the work object. In such cases, the communication platform may input the description to one or more machine-learned models trained to output a recommendation indicating the predicted likelihood of the work object pertaining to an ongoing conversation and/or an indication of a contextually appropriate layout(s) for rendering the work object and/or a work object channel in one or more virtual spaces. In such cases, the one or more machine-learned models may be trained on a list of one or more work objects that were generated at a previous time.

As illustrated by these examples, the techniques described herein can improve the functioning, efficiency, and overall user experience of a communication platform by determining prior to generating a work object whether the work object is predicted to be coherently associated with (or relevant to) an ongoing conversation, which may save computing resources that would be needed for returning contextually irrelevant query results (e.g., a server or other computing device retrieving messages, files, channels, users, etc. containing all or part of a search query but having no contextual relation to the work object). If the work object is associated with an ongoing conversation (e.g., contains files or attachments frequently referenced in a series of messages/replies) such that additional follow-up searches for the files are not needed, computing resources that would be used to locate and retrieve the files need not be utilized. Further, the conversation optimization techniques described herein may increase the likelihood of rendering work objects having contextually appropriate appearance or layout, rather than rendering uninformative work objects for which some or all of the relevant information is inaccessible to users without navigating away from a current virtual space. Further, such techniques enable third-party services (e.g., applications integrated within the communication platform to provide additional functionality) to specify a schema for work objects which may increase interoperability between third-party services by providing a standardized structure for describing data and thereby facilitating consistent information exchange. In addition, such techniques may improve the ability of the communication platform to integrate data (e.g., to map and/or combine related conversation data) from various sources (such as, for example, a retail company's customer purchase data from an online store and from its brick-and-mortar stores) thereby enabling a unified view of information for better insights and decision making. Lastly, such techniques can increase network bandwidth (due to processing of fewer work objects), increase processing speeds, reduce memory requirements needed to store information about additional work objects, reduce potential latency due to the network not being used for additional follow-up searches, etc.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Group-Based Communication System

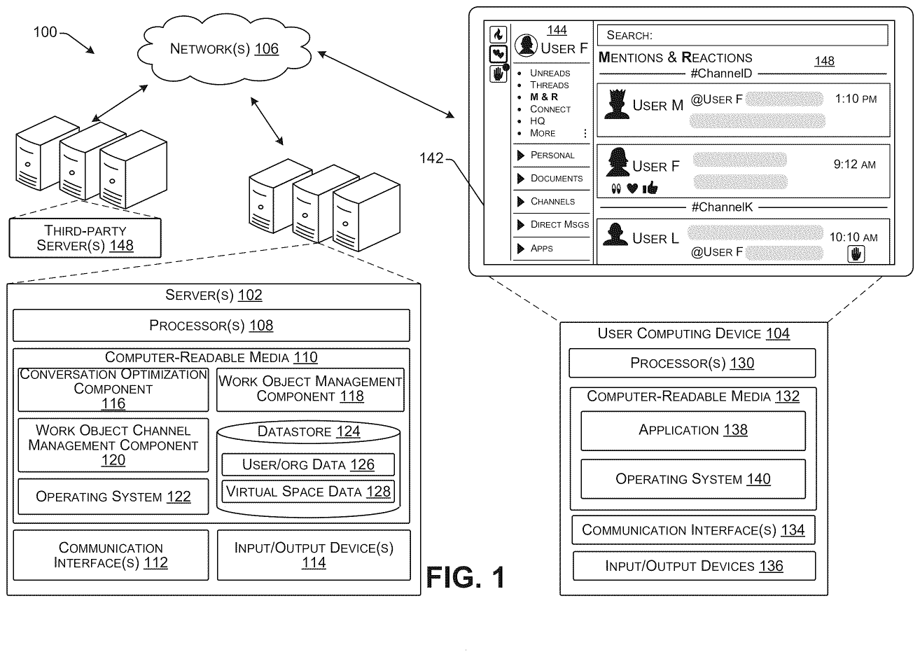

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group(s) of users. In some examples, such groups of users can be defined by group identifiers, which can be associated with common access credentials, domains, or the like. In some examples, the communication platform can be a hub, offering a secure and private virtual space to enable users to chat, meet, call, collaborate, transfer files or other data, or otherwise communicate between or among each other. Further, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities associated with different organization identifiers).

In at least one example, the example environment 100 can include one or more server computing devices (or “server(s)”) 102. In at least one example, the server(s) 102 can include one or more servers or other types of computing devices that can be embodied in any number of ways. For instance, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of, etc.) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and/or input/output devices 114.

In at least one example, each processor of the one or more processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media 110, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media 110 can optionally include a conversation optimization component 116, a work object management component 118, a work object channel management component 120, an operating system 122, and a datastore 124.

A work object may be generated by the communication platform such that it is “directly” associated with the communication platform. That is, the work object can be a “first-party work object.” In some examples, a work object associated with the communication platform can further be associated with (e.g., generated by) a third-party platform such that it is a “third-party work object.” A third-party platform can be external to the communication platform (e.g., a different entity or organization, outside the control or authority of the communication platform, etc.) and can be associated with the third-party server(s) 148, as illustrated in FIG. 1. In at least one example, a third-party platform can host, store, manage, or otherwise own one or more work objects. That is, a work object created by a third-party platform can be a “third-party work object” and can be hosted, stored, managed, or otherwise owned by the third-party platform. In some examples, a third-party work object can be associated with the communication platform by the provision of a resource locator associated with the third-party work object, a drag and drop action associated with the third-party work object (e.g., dragging the third-party work object from the third-party platform to the communication platform), being returned as a result of a search query initiated on the third-party platform, uploading the third-party work object from a storage repository, and/or the like. In at least one example, a third-party work object can be integrated into the communication platform (e.g., via one or more application programming interfaces (API(s)), plugins, and/or the like) such that the third-party work object can be accessed from within the communication platform. As one non-limiting example, a third-party platform may be an application lifecycle management (ALM) tool that is integrated into the communication platform. The techniques discussed herein may allow users to view, edit, create or otherwise interact with work objects associated with the ALM tool directly within the communication platform. In some examples, third-party work objects that can be associated with the communication platform can be determined by permission(s) provided by an administrator or the like.

In at least one example, the conversation optimization component 116 can be configured to determine whether a work object is coherently associated with one or more existing communication messages (e.g., ongoing conversations) based on metadata associated with the work object. In some examples, a user may request, via a virtual space (e.g., a scheduling service, channel, direct message, etc.), to generate a work object. That is, when creating the work object (e.g., the work object request), the requesting user may specify metadata (e.g., one or more users, roles, methods, and/or conditions, etc.) describing the attributes and behaviors attributed to the work object. Based on receiving the request from the requesting user, the conversation optimization component 116 may determine whether the work object is predicted to be pertinent to—or coherently associated with—an ongoing conversation by determining whether a sufficient amount (e.g., a threshold amount) of the underlying metadata is coherently associated with one or more known topics, channels, direct messages, canvases, boards, or the like. Accordingly, the conversation optimization component 116 may perform any appropriate natural language processing method to associate a work object and/or the underlying metadata with an ongoing conversation. For instance, the communication platform may determine that a work object is coherently associated with one or more conversations by analyzing keywords (e.g., a threshold number of conversations contain the same or similar keywords or phrases as contained in the work object), mentioned users (e.g., a same user is mentioned in a threshold number of conversations as is mentioned in the work object), channel topics or the like. Based on performing such process(es), the conversation optimization component 116 may generate a recommendation including a confidence level indicative of whether the work object is likely to be pertinent and/or a predicted context of the requested work object. In such cases, the conversation optimization component 116 may display the recommendation to the requesting user. In response to displaying the recommendation, the conversation optimization component 116 may receive user input data from the requesting user that may indicate an intent of the requesting user to generate the work object. Accordingly, the conversation optimization component 116 may generate work object data based on the user input data.

In at least one example, the work object management component 118 can receive work object metadata (e.g., from the conversation optimization component 116) to generate and/or render a work object in response to a request. In at least one example, generating and/or rendering a work object can include unfurling work object metadata (e.g., crawling the work object metadata, detecting a schema associated with the metadata, and determining a uniform summary of the metadata). Further, generating and/or rendering a work object can include associating a work object identifier with the work object. The work object identifier can be stored as metadata and include a unique code (e.g., numbers, letters, symbols, and/or a combination thereof) that can be used to identify the work object. In various examples, the work object identifier can include a same or similar identifier that is associated with a type of virtual space of the communication platform. For instance, the work object identifier can include a communication channel identifier (such as may be associated with a corresponding work object channel) that maps functionalities associated with communication channels to the work object and/or the associated work object channel. That is, the work object/work object channel can leverage existing infrastructure of the communication platform in a container that is associated with the work object based on an association of the work object identifier with the work object. In response to receiving the work object metadata, the work object management component 118 may generate the work object and/or the work object identifier.

In at least one example, the work object channel management component 120 can manage work object channels of the communication platform. In at least one example, the communication platform can be “channel-based” such that the platform can be organized into channels having security (that can be defined by permissions) to limit access to defined groups of users (e.g., members of the channels). A channel, or virtual space, can be a data route for exchanging data between and among systems and devices associated with the communication platform, such as content, messages, and/or the like. In some examples, a channel may be “public,” which may allow any user within a group (e.g., associated with an organization identifier, associated with a workspace identifier, etc.) with which the channel is associated to join and participate in the data sharing through the channel. In some examples, a channel may be “private,” which may restrict data communications in the channel to certain users or users having particular roles (e.g., managers, administrators, etc.) and/or types (e.g., verified, etc.). For purposes of this discussion, for instance, a work object channel can comprise a channel in which users participate in a data exchange related to and/or generated from a particular work object.

In some examples, a channel can be associated with a defined group of users within a same organization. Such a communication channel can be referred to as an “internal channel” or an “internally shared channel.” In some examples, a channel may be “shared” or “externally shared,” which may allow users associated with two or more different groups (e.g., entities associated with two or more different organization and/or work space identifiers) to join and participate in the data sharing through the channel. A shared channel may be public such that it is accessible to any user of groups associated with the shared channel, or may be private such that it is restricted to access by certain users or users having particular roles and/or types. A “shared channel” or an “externally shared channel” can enable two or more organizations, such as a first organization and a second organization to share data, exchange communications, and the like (hence, a “shared channel” or an “externally shared channel” can refer to a communication channel which is accessible across different organizations, wherein an “internal channel” or “internally shared channel” can refer to a channel which is accessible within the same organization). In an example, the first organization and the second organization can be associated with different organization identifiers, can be associated with different business entities, have different tax identification numbers, and/or otherwise be associated with different permissions such that users associated with the first organization and users associated with the second organization are not able to access data associate with the other organization without the establishment of an externally shared channel. In some examples, a shared channel can be shared with one or more different workspaces and/or organizations that, without having a shared communication channel, would not otherwise have access to each other's data by the nature of the permission-based and/or group-based configuration of the communication platform described herein.

In at least one example, the work object channel management component 120 can receive a request to generate a work object channel. In some examples, a request to generate a work object, as described herein, can comprise a request to generate a corresponding work object channel. In such circumstances, a work object channel can be generated at or near to the same time that a corresponding work object is generated. In some other circumstances, a request to generate a work object channel can be a separate or different request, such that it is received (e.g., by the work object channel management component 120) separately from a request to generate a work object. For instance, the communication platform (e.g., the work object management component 118) can cause an affordance associated with the work object to be presented in association with an existing virtual space. In such examples, members of the existing virtual space can access the work object channel via the affordance. In some examples, the request to generate the work object channel can include a name, title, or other identifier that is to be associated with the work object channel, one or more users to invite to join the work object channel, and/or permissions associated with the work object channel. Accordingly, in at least one example, one or more instances of metadata associated with a work object can be mapped to, or otherwise associated with, a corresponding work object channel (e.g., a work object channel identifier associated therewith).

User(s) associated with a work object channel can be “members” of the work object channel. Members of a work object channel can communicate with other members via the work object channel. That is, in at least one example, the work object channel management component 120 can establish a work object channel between and among various user computing devices associated with user identifiers associated with the work object channel, allowing the user computing devices to communicate and share data between and among each other. As described herein, in some examples, such communication and/or sharing of data can be via one or more messages that can be exchanged via the work object channel. In at least one example, the work object channel management component 120 can manage such communications and/or sharing of data. For instance, the work object channel management component 120 of various examples can determine that a message, post, entry, file, image, etc. is not coherently related to (e.g., as compared to a threshold) a work object, such that it should be removed and/or routed to a different channel.

As described above, in at least one example, one or more permissions (such as indicated e.g., by metadata underlying a work object) can be mapped to, or otherwise associated with, a work object channel and/or members associated therewith. Such permission(s) can indicate which user(s) have permission to access the work object channel, actions and/or messages permitted in the channel, which user(s) and/or type(s) of users are permitted to add or remove members, which user(s) and/or types of users are permitted to share the work object channel with other users, a retention policy associated with data in the work object channel, whether the work object channel is public or private, or the like.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include conversation data (e.g., textual data, audio data, video data), images, files, and/or any other type of data configured to be transmitted in association with a virtual space. Non-limiting examples of virtual spaces include workspaces, communication channels (including, but not limited to work object channels), direct messaging instances, collaborative documents, canvases, and audio and/or video conversations. In at least one example, the virtual space data 128 can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a work object that is generated in association with a work object channel may be stored in association with the work object channel and vice versa.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 108 and may be the same as or different than the processor(s) 108.

The computer-readable media 132 can comprise any of the types of computer-readable media 132 described above with reference to the computer-readable media 110 and may be the same as or different than the computer-readable media 110. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices associated with the environment 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 138 can present user interfaces, as described herein. In at least one example, a user can interact with the user interfaces via touch input, keyboard input, mouse input, spoken input, or any other type of input.

A non-limiting example of a user interface 142 is shown in FIG. 1. As illustrated in FIG. 1, the user interface 142 can present data associated with one or more virtual spaces, which may include one or more work objects and/or work object channels. That is, in some examples, the user interface 142 can integrate data from multiple workspaces that is contextually relevant or otherwise associated with a work object into a single user interface so that the user (e.g., of the user computing device 104) can access and/or interact with data associated with the multiple workspaces that he or she is associated with and/or otherwise communicate with other users associated with the multiple workspaces. In some examples, the user interface 142 can include a first section 144, or pane, that includes indicator(s) (e.g., user interface element(s) or object(s)) associated with workspace(s) with which the user (e.g., account of the user) is associated.

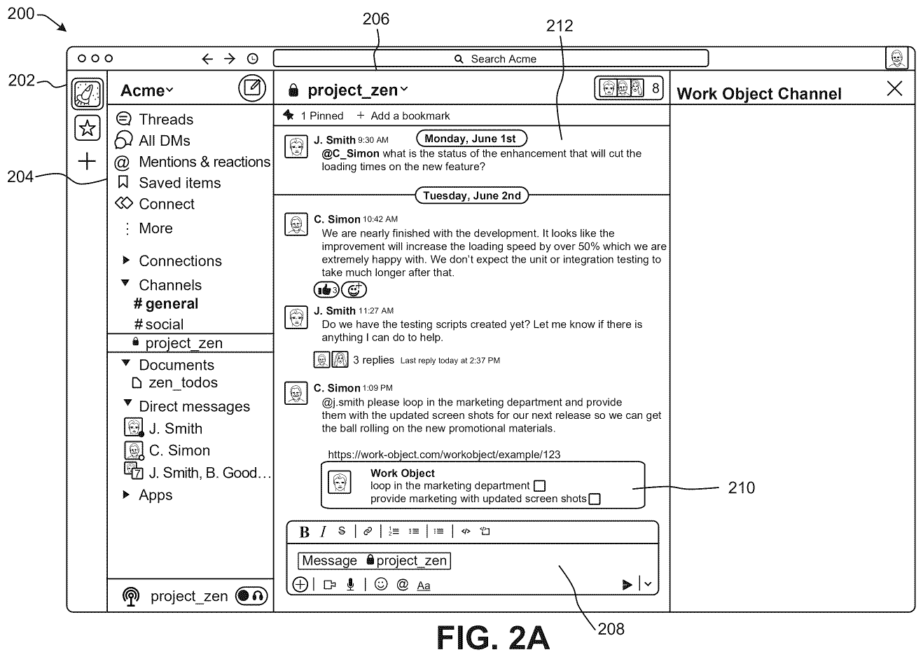

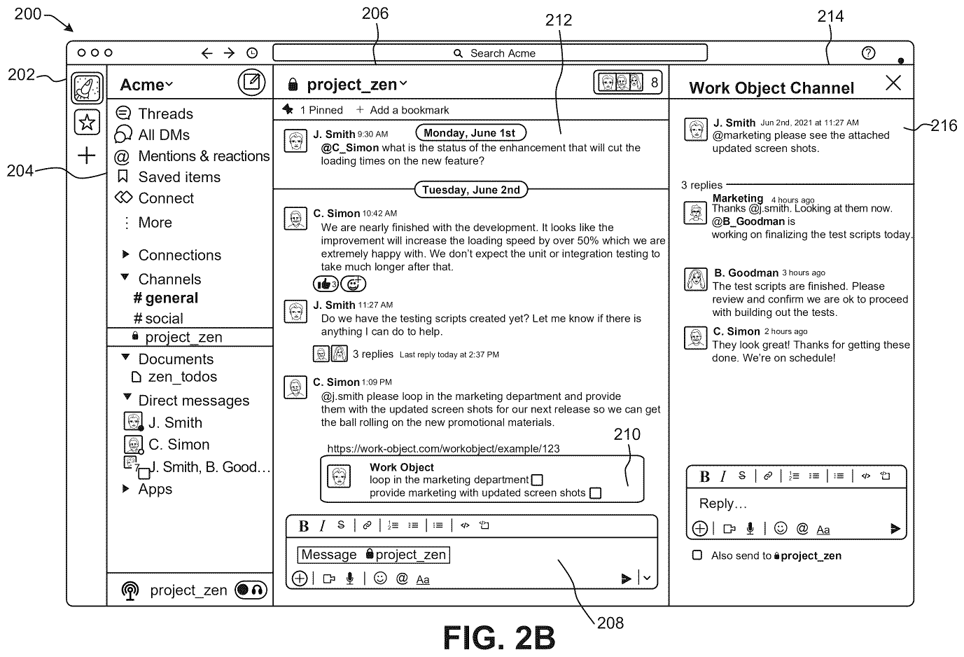

By way of example and without limitation, when a user opens the user interface 142 they can select a workspace via the first section 144. A particular workspace may be associated with data specific to the workspace and accessible via permissions associated with the workspace. For example, and as described in further detail with reference to FIGS. 2A-2B, the Acme company may have a workspace for Acme projects, such as Project Zen, a workspace for social discussions, and an additional workspace for general company matters. In some examples, an organization, such as a particular company, may have a plurality of workspaces, and the user may be associated with one or more workspaces belonging to the organization. In yet other examples, a particular workspace can be associated with one or more organizations or other entities associated with the group-based communication system. Different graphical indicators may be associated with virtual spaces (e.g., channels) to summarize an attribute of the channel (e.g., whether the channel is public, private, shared between organizations, locked, etc.).

In some examples, a virtual space can be associated with the same type of event and/or action. For example, “threads” can be associated with messages, files, etc. posted in threads to messages posted in a virtual space and “mentions and reactions” can be associated with messages or threads where the user has been mentioned (e.g., via a tag) or another user has reacted (e.g., via an emoji, reaction, or the like) to a message or thread posted by the user. That is, in some examples, the same types of events and/or actions, which can be associated with different virtual spaces, can be presented via the same feed. As with the “unreads” virtual space, data associated with such virtual spaces can be organized and/or is sortable by virtual space, time, type of action, user, and/or the like.

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers may comprise American Standard Code for Information Interchange (ASCII) text, a pointer, a memory address, or the like.

In some examples, a virtual space can be associated with one or more work objects with which the user is associated. In at least one example, the work objects, as described herein, can be associated with an individual (e.g., private work object for a user), a group of users (e.g., collaborative work object), and/or one or more communication channels (e.g., members of the communication channel rendered access permissions to the work object), such as to enable users of the communication platform to create, interact with, and/or view data associated with such work objects. In some examples, the work object can be or otherwise facilitate access to a virtual space, a board, a canvas, a page, or the like for collaborative communication and/or data organization within the communication platform. In some examples, the work object can be associated with permissions defining which users of a communication platform can access, view, interact with, and/or edit the work object. In some examples, a work object can be associated with a communication channel, and members of the communication channel can view and/or edit the work object. Additional details of the presentation of a particular work object are described below with respect to FIGS. 2A and 2B.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

While techniques described herein are described as being performed by the conversation optimization component 116, the work object management component 118, the work object channel management component 120, and the application 138, techniques described herein can be performed by any other component, or combination of components, which can be associated with the server(s) 102, the user computing device 104, or a combination thereof.

### Work Objects and Work Object Channels Within a Group-Based Communication System

FIG. 2A illustrates a user interface 200 of a communication platform, which will be useful in illustrating the operation of various examples discussed herein. The user interface 200 can correspond to the user interface 142 described above with reference to FIG. 1. As described above, in some examples, a user interface 200 presented via the communication platform can include a first section 202 (which can correspond to the first section 144 described above with reference to FIG. 1) that includes user interface element(s) representing virtual space(s) with which the user (e.g., a user identifier of the user) is associated. In at least one example, the first section 202 can include one or more subsections, which can include user interface element(s) representative of different virtual spaces. For example, a first subsection 204 can include user interface elements representing virtual spaces (e.g., threads, direct messages (DMs), mentions and reactions, etc.) that can aggregate data associated with a plurality of channels and/or workspaces. In at least one example, each virtual space can be associated with a user interface element in the first subsection 204. In some examples, a user interface element can be associated with an actuation mechanism, that when actuated, can cause the application 138 to present data associated with the corresponding virtual space via a third section 206 of the user interface 200 (which can correspond to the second section described above with reference to FIG. 1). In the depicted example, the application 138 has caused data associated with the virtual space entitled “project_zen” to be presented via the third section 206.

The third section 206 may include messages such as message 212, which is content posted by a user (e.g., J. Smith) into a virtual space represented by the user interface 200. Users may post text, images, videos, audio, or any other file as the message 212. In some examples, particular identifiers (in messages or otherwise) may be denoted by prefixing them with predetermined characters. For example, channels may be prefixed by the “#” character (as in #project_zen) and username may be prefixed by the “@” character (as in @J_Smith or @User_A). Accordingly, messages such as the message 212 may include an indication of which user posted the message and the time at which the message was posted. In the illustrated example, the compose pane 208 allows users to compose and transmit messages 212 to the members of the channel or virtual space or to those members of the channel or virtual space who are following (e.g., subscribed to) the thread (when the message is sent in a thread). The compose pane 208 may have text editing functions such as bold, strikethrough, and italicize, and/or may allow users to format their messages or attach files such as images, videos, or any other files to share with other members of the channel. In some examples, the compose pane 208 may enable additional formatting options such as numbered or bulleted lists via either the user interface or an API.

The compose pane 208 may also function as a work object trigger to initiate (e.g., request) creation of work objects within a channel or virtual space. As described herein, a message composed and posted to a virtual space may comprise a request to generate a work object. That is, the user may request, generate, or otherwise access a work object with which the user is associated via the compose pane 208. In such circumstances, the communication platform may crawl links, documents, messages, etc. that are sent via the compose pane 208 to identify work object metadata and/or unfurl instructions related to how the work object should be displayed. In the example depicted in FIG. 2A, the work object is associated with a message composed by user “C. Simon” at 1:09 pm via the compose pane 208. Further as described herein, the communication platform may determine a schema associated with a work object. For purposes of this discussion, the communication platform has determined the requesting user's (“C. Simon”) intent for the work object to be generated and rendered as a “task” work object. For instance, the communication platform of the illustrated example can be configured to crawl the message posted by C. Simon at 1:09 pm and/or the underlying work object metadata to identify context (such as one or more roles (e.g., “J. Smith”) and action steps (e.g., “loop in the marketing department” and “provide marketing with updated screen shots”)) and render the work object as a uniform summary or “rich preview” of the action to be undertaken. For illustrative purposes, and not to be taken as limiting, the communication platform has determined two action steps to be performed by user J. Smith and thus rendered the depicted work object as having task-type affordances (e.g., checkboxes) and depicting an avatar associated with user J. Smith who is to perform the action steps. In at least some examples, a layout or organization of a work object can be pre-formatted according to schema. Thus, the communication platform of various examples can render (based on the work object metadata) the work object 210 as including one or more approval-type affordances (e.g., an affordance for digitally signing documents without leaving the user interface 200, etc.), one or more call-type affordances (e.g., user interface elements enabling voice and/or video calling without leaving the user interface, etc.), email-type affordances (e.g., one or more user interface elements for sending emails from/receiving emails to a virtual space) or the like.

Turning now to FIG. 2B, the user interface 200 can include a fourth region 214, or pane, that can be associated with a work object channel (or data feed) indicating messages that are contextually related to and/or actions taken with respect to one or more work objects as described herein. That is, the fourth region 214 can comprise a centralized aggregate of inter-related communications that enables users to associate communications from virtual spaces across the communication platform therein without requiring users to scroll and/or navigate extensively to meaningfully participate in such communication. That is, in some examples, the fourth region 214 (e.g., the work object channel) can present data associated with the same or different workspaces via an integrated feed. Thus, in some examples, the data (e.g., communications) associated with the fourth region 214 can be organized and/or is sortable by virtual space (e.g., an originating workspace), time (e.g., when associated data is posted or an associated operation is otherwise performed), type of action, communication channel, user, or the like. In the depicted example, the work object channel (e.g., the fourth region 214) comprises a plurality of contextually related messages. In particular, a first displayed message 216 is representative of a first contextually related message posted by a target user (“J. Smith”) of the work object 210. That is, the first displayed message 216 represents a first message posted by the user “J. Smith” in furtherance of the work object 210. Accordingly, the first displayed message 216 @-mentions (i.e., “loops in”) a marketing department and includes attached updated screenshots (i.e., “provides marketing with the updated screenshots). Though, other configurations of the data feed comprising the work object channel are contemplated. For instance, the work object channel (e.g., the fourth region 214) may be populated with a threshold number (e.g., 1, 5, 10, etc.) of related messages that preceded a work object, a threshold number (e.g., 1, 5, 10, etc.) of related messages subsequent to the work object, a threshold number of messages (e.g., 1, 5, 10, etc.) originating from a virtual space wherein a work object was substantially completed, or the like. In at least one example, in response to receiving an indication of selection of the work object 210 (e.g., an affordance associated therewith), the communication platform can cause the fourth region 214 to be presented. For instance, in response to receiving the indication of selection of the work object 210, the fourth region 214 may be resized or popped out as a standalone window. In some other instances, the fourth region 214 may be generated and/or presented automatically.

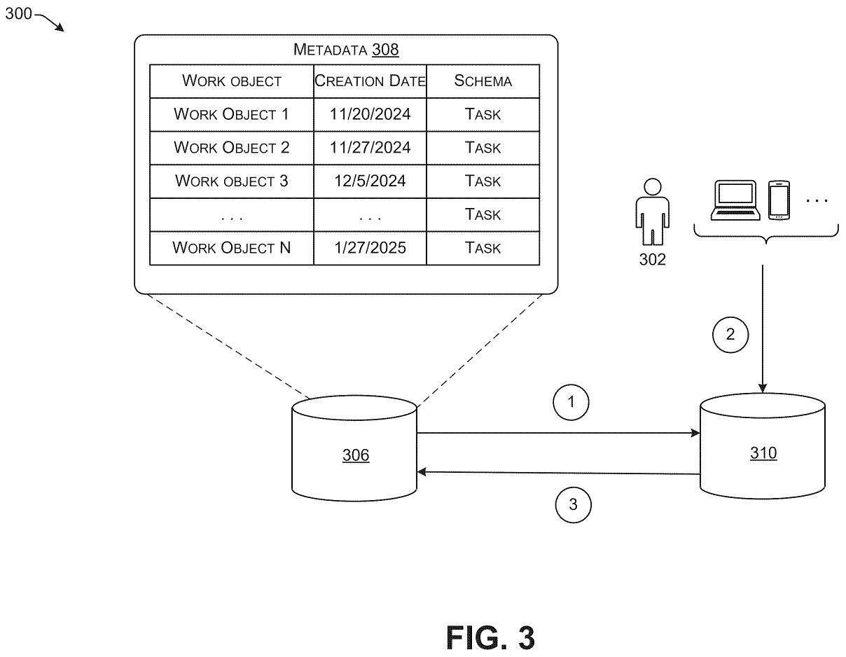

FIG. 3 illustrates a pictorial flow diagram of an example process 300 for emitting typed metadata into a communication platform. In various examples, the example process 300 may be initiated or otherwise undertaken by a user 302 (e.g., via a user device). In some cases, the user 302 may be a developer associated with an organization. For instance, a software development company may leverage a communication platform (e.g., one or more work object channels thereof) for each software product being developed. Accordingly, the user 302 may wish to emit typed metadata (e.g., work object metadata) to the communication platform in order to leverage work object functionality within the communication platform. In the illustrated example, operation 304 (indicated by the numeral “1”) thus comprises importing (e.g., from a repository or data store owned or otherwise controlled by the communication platform, such as the depicted repository 306) one or more schemas and associated descriptions employed by the communication platform. In some cases, the operation 304 may comprise importing a source file 308 (e.g., a CSV file, XML file, or the like). In such cases, the source file may specify a target location (e.g., a repository or data store owned or otherwise controlled by the software development company of the present example, such as the depicted repository 310). While depicted for ease of understanding as comprising only instances of “task” work objects, this is not meant to be limiting and it will be understood that the communication platform may own or otherwise maintain any appropriate number of metadata schemas for defining the overall structure of metadata. Metadata (e.g., the metadata represented in the source file 308) may persist and be accessed in tables. In some examples, the tables are implemented in connection with a database environment associated with a serverless execution environment in which a particular event-based application is executing. In some instances, tables may be provided in connection with a relational database environment. In other examples, tables are provided in connection with a database mechanism that does not employ relational database techniques. Although not shown, in some examples, reading or writing certain data to one or more of tables, or data in table matching predefined conditions, is itself a precipitator or “trigger” for creation of a work object. For example, if tables are used to maintain ticketing data in a computer environment of the software development company in the above example, then a count of open tickets associated with certain metadata fields exceeding a predetermined threshold may trigger a message (e.g., a request to generate a work object) being posted in an incident-management channel in the communication platform.

At operation 312 (indicated by the numeral “2”), the user 302 (or other entity) may transmit data (e.g., documentation, descriptions, metadata, or any other data usable to define metadata according to a schema of the communication platform to the repository 310. In some examples, APIs (not shown) are associated with third-party services to provide a custom integration between a particular third-party service and a communication platform. Examples of third-party service integrations include video conferencing, sales, marketing, customer service, project management, and engineering application integration or the like. In such an example, an API call to a third-party video conferencing provider by way of an API. As such, an API may trigger the operation 312 or events associated therewith. Continuing this example, successful completion of a video conference could trigger an API call to the third-party video conference provider to facilitate downloading and/or archiving data associated with the video conference and storing the same (e.g., in the repository 310). For instance, metadata associated with the video conference may be parsed and/or organized into a format satisfying a schema associated with the communication platform.

At operation 314 (indicated by the numeral “3”), the user 302 may emit the typed metadata to the communication platform (e.g., the depicted repository 306). In some examples, a third-party work object can be associated with the communication platform by the provision of a resource locator associated with the third-party work object, a drag and drop action associated with the third-party work object (e.g., dragging the third-party work object from the third-party platform to the communication platform), being returned as a result of a search query initiated on the third-party platform, uploading the third-party work object from a storage repository (e.g., the depicted repository 310), and/or the like. In at least one example, a third-party work object can be integrated into the communication platform (e.g., via one or more application programming interfaces (API(s)), plugins, and/or the like) such that the third-party work object can be accessed from within the communication platform. In some examples, third-party work objects that can be associated with the communication platform can be determined by permission(s) provided by an administrator or the like.

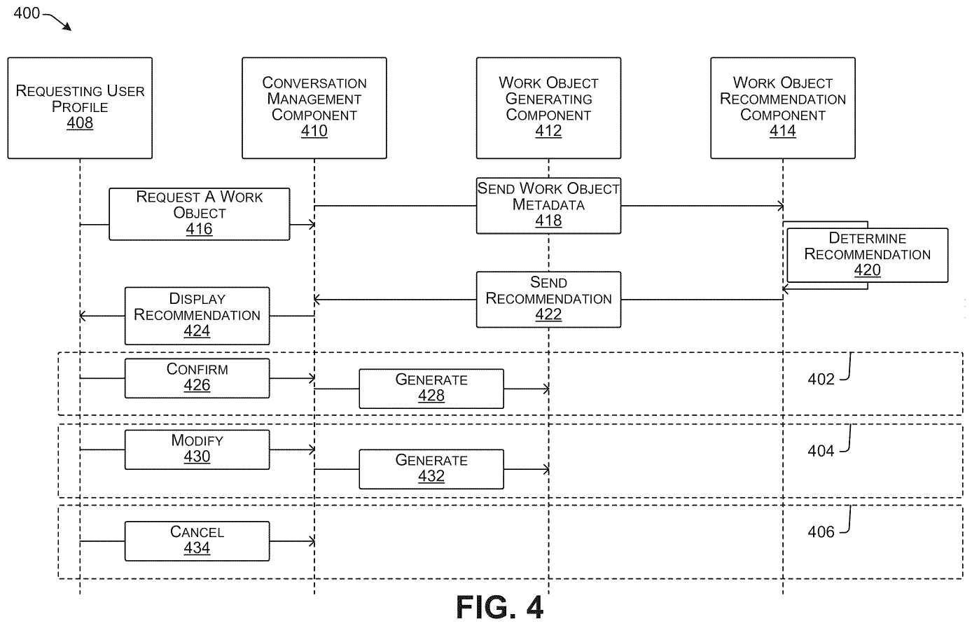

FIG. 4 illustrates a sequence diagram of an example process 400 for requesting to create a work object according to a schema, determining a recommendation based on the request, receiving user input data based on the recommendation, and determining whether to generate the work object based on the recommendation. The operations described with respect to FIG. 4 may be performed in the order shown in FIG. 4 and/or in any other order. Additionally, at least some of the operations may be performed in parallel. Further, block 402 may include a first set of operations that result in a user confirming the generation of a work object, block 404 may include a second set of operations that result in a user modifying work object metadata, and block 406 may include a third set of operations that result in the cancelation of a work object (or the associated request to generate the work object). However, the operations in the block 402, the block 404, and/or the block 406 may be performed in the same or different user experiences. That is, in some examples, the operations in block 402 may be performed without performing the operations in block 404 and/or block 406, and vice-versa.

In this example, FIG. 4 may include one or more components which may receive, analyze, and/or transmit data. Such components may include a requesting user profile 408, a conversation management component 410, a work object generating component 412, and/or a work object recommendation component 414. In some examples, such components may be configured to perform one or more functions in the described conversation optimizing technique.

At block 416, the requesting user profile 408 may submit a request to generate a work object (or a message) via a user interface of a communication platform. That is, the requesting user profile 408 may create a message that includes fully qualifying work object metadata. The work object metadata may include various criteria for validating the work object against a schema. In some examples, the requesting user profile 408 may submit the request to generate the work object (and the work object metadata) which may be sent to a conversation management component 410. In some examples, the conversation management component 410 may be a system (or subsystem) configured to manage and/or control the aggregation of contextually related conversations (such as work objects, messages, direct messages, threads, etc.) within a communication platform.

At block 418, the conversation management component 410 may send the work object metadata (e.g., the work object criteria) to the work object recommendation component 414. In some examples, the work object recommendation component 414 may analyze the work object metadata to determine a predicted level of coherent (or contextual) association for the work object within the communication platform based on the work object metadata.

That is, at block 420, the work object recommendation component 414 may determine whether the work object metadata satisfies a known schema associated with the communication platform. In such cases, the work object recommendation component 414 may identify communication platform data including user profile data corresponding to the user profile of the requesting user profile, organization data, virtual space data, historical data, conversation data (e.g., message logs, call transcripts, comment threads, feeds, etc.) or the like and compare such data with the work object metadata. The work object recommendation component 414 may generate and/or determine a recommendation that indicates whether the work object is likely to be coherently (e.g., contextually) associated with one or more ongoing conversations based on the comparison between the communication platform data and the work object metadata.

At block 422, the work object recommendation component 414 may send the recommendation to the conversation management component 410. That is, the work object recommendation component 414 may send the recommendation to a virtual space of the communication platform (e.g., the virtual space within which the requesting user profile 408 generated the request for the work object). At block 424, the conversation management component 410 may cause the recommendation to be displayed to a user interface of the requesting user profile 408. In such cases, the recommendation may be an actionable notification. That is, the recommendation may include one or more user interface components (e.g., buttons, checkboxes, dropdown menus, sliders, etc.) by which the requesting user profile 408 may confirm the requested work object, cancel the requested work object, and/or modify the requested work object.

At block 426, the requesting user profile 408 may send a confirmation of the requested work object to the conversation management component 410. That is, the requesting user profile 408 may transmit a request that the work object generating component 412 generate the work object according to the current work object metadata. As such, at block 428, the conversation management component 410 may send the work object metadata (e.g., the work object criteria) to the work object generating component 412 which may be configured to generate the work object.

Additionally or alternatively, at block 430, the requesting user profile 408 may send a request to the conversation management component 410 to modify the work object criteria. That is, the requesting user profile 408 may determine one or more alternative work object criteria (e.g., a different schema, add or remove one or more keywords/usernames, etc.) to increase the likelihood that the requested work object is coherently associated with relevant conversations. In this example, at block 432, the conversation management component 410 may send the updated or alternative work object criteria to the work object generating component 412 which may be configured to generate the work object according to the updated or alternative work object criteria.

Additionally or alternatively, at block 434, the requesting user profile 408 may transmit a request (or instructions) to the conversation management component 410 to cancel the requested work object. That is, based on the displayed recommendation, the requesting user profile 408 may determine that the work object may have a low likelihood of being coherently associated with an ongoing conversation (e.g., is unlikely to be returned in relevant queries, is unlikely to be the root of subsequent messaging threads, etc.) and as such, the requesting user profile 408 may instruct the conversation management component 410 to refrain from generating a work object.

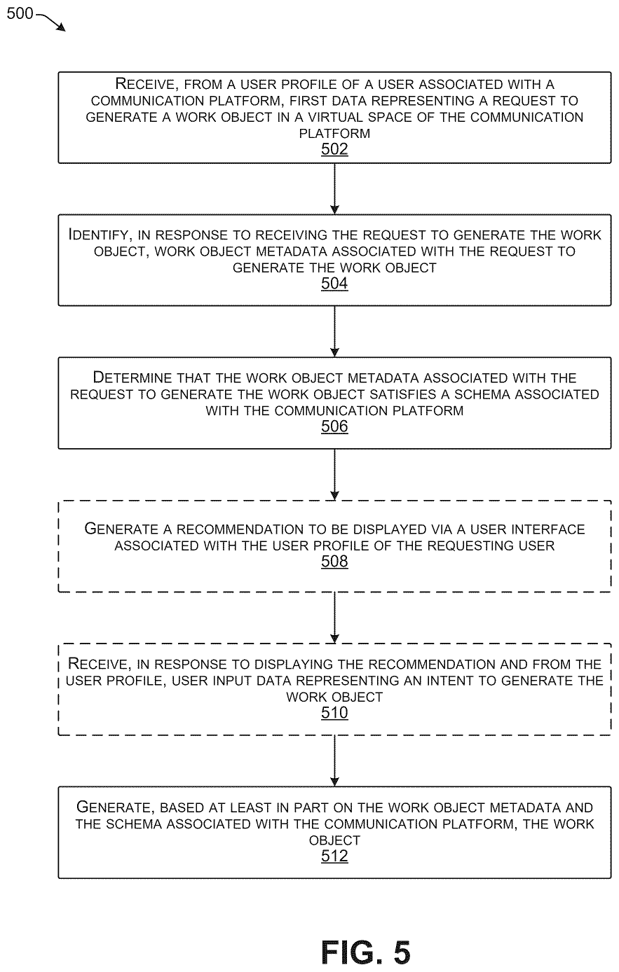

FIG. 5 is a flow diagram illustrating an example process 500 of receiving a request to generate a work object, identifying work object metadata associated with the request to generate the work object, determining that the work object metadata associated with the request to generate the work object satisfies a schema, and generating the work object based at least in part on the metadata and the schema. The processes illustrated in FIG. 5 are described with reference to components described above with reference to the example environment 100 shown in FIG. 1 for convenience and ease of understanding. However, the processes illustrated in FIG. 5 are not limited to being performed using the components described above with reference to the example environment 100. Moreover, the components described above with reference to the example environment 100 are not limited to performing the processes illustrated in FIG. 5.

Process 500 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 502, the process 500 can include receiving, from a user profile of a user associated with a communication platform, first data representing a request to generate a work object in a virtual space of the communication platform. In some instances, the requesting user can use a device (or user device) to submit, from the user profile of the requesting user, a request to generate a work object. That is, the requesting user may create a message (e.g., calendar invite, direct message, etc.) that includes the request to generate the work object. For instance, the requesting user may transmit the request to generate the work object within a virtual space (e.g., a communication channel) of the communication platform. As such, the communication channel may be a dedicated virtual space of the communication platform wherein conversations are organized around one or more topics. The request to generate the work object may, in such cases, therefore comprise a message pertaining to a relevant topic. A work object may be an event, a meeting, a job, and/or any other type of activity that adheres to a known schema of the communication platform and may be completed within and/or facilitated by the communication platform. A requesting user may be any user or user type (e.g., administrative user, managing user, and/or any other user) that creates and/or publishes work objects within the communication platform.

At operation 504, the process 500 can include identifying, in response to receiving the request to generate the work object, work object metadata associated with the request to generate the work object. For instance, when requesting to generate the work object, the requesting user may specify one or more work object criteria. Such work object criteria may be structured data payloads that include information about the work object. As described throughout, in some examples, a requesting user may create a message that includes a request to generate a work object. In such cases, the work object criteria can be configured as part of the message's metadata property. For instance, such work object criteria can be represented substantially in the form of Java Script Object Notation (JSON) or the like. In some examples, the work object metadata associated with the request to generate the work object may include various types of metadata. For example, the work object metadata may include role metadata that describes the role(s) and/or types of role(s) the users of the communication platform may perform (or be associated with). In some examples, some types of roles may include position metadata (e.g., systems administrator, sales representative, software engineer, team lead, vice president of sales, vice president of marketing, marketing manager, head of legal, etc.), profession metadata (e.g., legal, business, marketing, administration, human resources, etc.), team metadata (e.g., mechanical team, electrical team, sales team, marketing team, backend team, front end development team, etc.), resource metadata (e.g., conference room, nails, cars, trucks (e.g., truck dimensions), etc.), asset metadata (e.g., equipment, property, etc.), and/or any other type of metadata.

At operation 506, the process 500 can include determining that the work object metadata (e.g., the work object criteria) associated with the request to generate the work object satisfies a schema associated with the communication platform. In some examples, a schema may be satisfied based on the metadata input to each prerequisite metadata field associated with a work object. That is, a communication platform of various examples can validate work object metadata against one or more predefined schemas of the communication platform prior to generating a requesting work object. For instance, the communication platform of some examples can crawl the work object metadata to identify an explicit schema property (e.g., “task” or “call”) represented in the work object metadata. In some other instances, the communication platform can compare the work object data to one or more predefined expressions (e.g., structures and/or data types) associated with the communication platform schema. For instance, an exemplary “task” schema associated with a communication platform may require input to each of a “users” metadata field (which may accept, e.g., an array of user strings) and a “tasks” metadata field (which may accept, e.g., an array of tasks). Though, the foregoing example of a schema is not intended to be limiting. In some examples, the work object metadata associated with a request to generate a work object can be configured to satisfy any of an approval schema, an email schema, a call schema, or any other schema utilized by a communication platform to define how metadata is structured and organized. Based on comparing the structures and/or data types input to each prerequisite metadata field against those of the “task” schema of the foregoing example, the communication platform may determine whether or not the work object satisfies the “task” schema.

Additionally, or alternatively, as illustrated at optional operation 508 (depicted in broken lines), the communication platform may generate a recommendation that indicates a predicted level of relevance (and/or a predicted context) for the requested work object. For example, if the communication platform determines that all (or a threshold amount) of the underlying work object metadata (e.g., users/usernames, roles, conditions, objectives/goals, etc.) contained in the work object metadata is coherently associated with a known topic, channel, direct message, thread or the like, the communication platform may generate a recommendation that indicates a high likelihood of the work object pertaining to an ongoing conversation. In such cases, the communication platform may identify the ongoing conversation to which the work object pertains by reference in the recommendation—for example by referencing a unique conversation identifier associated with the pertinent ongoing conversation. Otherwise, if the communication platform determines that less than a threshold amount of the underlying work object metadata is coherently associated with a known topic, channel, direct message or the like, then the communication platform may generate a recommendation that indicates a moderate to low likelihood of the work object pertaining to an ongoing conversation. Thus, at optional operation 508, the process 500 can also include causing the recommendation to be displayed via a user interface associated with the user profile of the requesting user. The communication platform may display or otherwise render the recommendation to the virtual space within which the organizing user profile submitted the event request. However, that is not intended to be limiting; in other examples, the recommendation may be displayed to any other virtual space in the communication platform. That is, the recommendation may be displayed as a separate interface such as an overlay interface, a pop-up box, and/or any other type of interface. In some examples, the recommendation may be actionable enabling a user to cancel the request, confirm the request (e.g., instruct the communication platform to generate the work object), and/or modify the request (e.g., modify the work object criteria) such that the predicted level of coherent association with an ongoing conversation increases.

At optional operation 510 (depicted in broken lines), the process 500 can include receiving, in response to displaying the recommendation and from the user profile, user input data representing an intent to generate the work object. User input data may include any type of input (e.g., audio data (e.g., voice command), physical input (e.g., touch), etc.) provided by a user profile (e.g., the user profile of the requesting user). As indicated above, the user input data may include a request (or intent) to cancel the request to generate the work object (e.g., the requesting user profile may determine that it may be beneficial to not generate the work object because the recommendation indicated that the work object is predicted to be contextually unrelated to any conversation within the communication platform), a request (or intent) to confirm the request to generate the work object, or a request to modify the request to generate the work object (or the work object criteria). If the user input data includes a request to cancel the work object, the communication platform may cancel the request and ensure that the work object does not get generated and/or does not become associated with any conversations and/or messages within the communication platform. If the user input data includes a request to confirm the work object, the communication platform may generate the work object and associate the work object with the identified relevant conversation(s) within a virtual space (e.g., by aggregating the relevant conversations within an associated work object channel) where user profiles associated with the work object and/or the related conversation(s) may be able to access or otherwise participate in such related conversations (e.g., based on permissions associated with the virtual space, the conversation(s) and/or the user profiles). If the user input data includes a request to modify the work object, the communication platform may re-evaluate the work object based on modified work object metadata (e.g., modified work object criteria) and generate an updated recommendation according to the modified work object metadata. Alternatively or additionally, the communication platform may generate a work object based on the modified work object metadata.

At operation 512, the process 500 can include generating, based at least in part on the work object metadata and the schema associated with the communication platform, the work object. That is, the communication platform can generate and/or render the work object as having an organization or “layout” based on the schema (e.g., a “task” schema can be rendered having one or more task-type affordances including, but not limited to, checkboxes, progress indicators (e.g., progress bars, percentage indicators, or the like), drag-and-drop functionality (e.g., to allow users to reorder or otherwise prioritize action items) or the like. As noted above, if the user input data includes a request to confirm the work object, the communication platform may generate the work object and associate the work object with the identified relevant conversation(s) within a virtual space (e.g., by aggregating the relevant conversations within an associated work object channel) where user profiles associated with the work object and/or the related conversation(s) may be able to access or otherwise participate in such related conversations (e.g., based on permissions associated with the virtual space, the conversation(s) and/or the user profiles).

### Example Clauses

A: system comprising: one or more processors; and one or more non-transitory computer-readable media storing computer-executable instructions that, when executed, cause the one or more processors to perform operations comprising: receiving, from a user profile of a user associated with a communication platform, first data representing a request to generate a work object in a virtual space of the communication platform; identifying, in response to receiving the first data representing the request to generate the work object, work object metadata associated with the request to generate the work object; determining that the work object metadata associated with the request to generate the work object satisfies a work object schema associated with the communication platform; and generating, based at least in part on the work object metadata and the work object schema, the work object.
B: The system of paragraph A, wherein the work object metadata associated with the request to generate the work object satisfies one of: a task work object schema defining requisite metadata to implement a task event, an approval work object schema defining requisite metadata to implement an approval event, an email work object schema defining requisite metadata to implement an email event, or a call work object schema defining requisite metadata to implement a call event.
C: The system of paragraph B, the operations further comprising: rendering, in a user interface of the virtual space and based at least in part on the work object schema associated with the communication platform, the work object as a uniform summary of the work object metadata; and unfurling, in response to receiving user input associated with the work object, the work object to display an unfurled work object, wherein the unfurled work object comprises one or more affordances associated with the work object schema associated with the communication platform.
D: The system of paragraph A, wherein the virtual space of the communication platform is a communication channel, the operations further comprising: generating a work object channel associated with the work object, wherein generating the work object channel associated with the work object comprises associating a work object identifier associated with the work object with a communication channel identifier associated with the communication channel such that the work object channel is configured to allow users of the communication platform to create, view, and interact with data associated with the work object.
E: The system of paragraph D, the operations further comprising receiving an indication of a selection of the work object, wherein the work object channel associated with the work object is generated in response to receiving the indication of the selection of the work object.
F: The system of paragraph A, the operations further comprising: generating, in response to receiving the first data representing the request to generate the work object, a recommendation indicating a likelihood that the work object is coherently associated with one or more conversations within the communication platform; and receiving, from the user profile of the user associated with the communication platform, second data representing a confirmation of the request to generate the work object.
G: The system of paragraph A, wherein the first data representing the request to generate the work object comprises a message posted in the virtual space of the communication platform.
H: A method comprising: receiving, from a user profile of a user associated with a communication platform, first data representing a request to generate a work object in a virtual space of the communication platform; identifying, in response to receiving the first data representing the request to generate the work object, work object metadata associated with the request to generate the work object; determining that the work object metadata associated with the request to generate the work object satisfies a work object schema associated with the communication platform; and generating, based at least in part on the work object metadata and the work object schema, the work object.
I: The method of paragraph H, wherein the work object metadata associated with the request to generate the work object satisfies one of: a task work object schema defining requisite metadata to implement a task event, an approval work object schema defining requisite metadata to implement an approval event, an email work object schema defining requisite metadata to implement an email event, or a call work object schema defining requisite metadata to implement a call event.
J: The method of paragraph I, further comprising: rendering, in a user interface of the virtual space and based at least in part on the work object schema associated with the communication platform, the work object as a uniform summary of the work object metadata; and unfurling, in response to receiving user input associated with the work object, the work object to display an unfurled work object, wherein the unfurled work object comprises one or more affordances associated with the work object schema associated with the communication platform.
K: The method of paragraph of H, wherein the virtual space of the communication platform is a communication channel, the operations further comprising: generating a work object channel associated with the work object, wherein generating the work object channel associated with the work object comprises associating a work object identifier associated with the work object with a communication channel identifier associated with the communication channel such that the work object channel is configured to allow users of the communication platform to create, view, and interact with data associated with the work object.
L: The method of paragraph K, the operations further comprising receiving an indication of a selection of the work object, wherein the work object channel associated with the work object is generated in response to receiving the indication of the selection of the work object.
M: The method of paragraph H, the operations further comprising: generating, in response to receiving the first data representing the request to generate the work object, a recommendation indicating a likelihood that the work object is coherently associated with one or more conversations within the communication platform; and receiving, from the user profile of the user associated with the communication platform, second data representing a confirmation of the request to generate the work object.
N: The method of paragraph H, wherein the first data representing the request to generate the work object comprises a message posted in the virtual space of the communication platform.
O: One or more non-transitory computer-readable media storing computer-executable instructions that, when executed by one or more processors, cause the one or more processors to perform operations comprising: receiving, from a user profile of a user associated with a communication platform, first data representing a request to generate a work object in a virtual space of the communication platform; identifying, in response to receiving the first data representing the request to generate the work object, work object metadata associated with the request to generate the work object; determining that the work object metadata associated with the request to generate the work object satisfies a work object schema associated with the communication platform; and generating, based at least in part on the work object metadata and the work object schema, the work object.
P: The one or more non-transitory computer-readable media of paragraph O, wherein the work object metadata associated with the request to generate the work object satisfies one of: a task work object schema defining requisite metadata to implement a task event, an approval work object schema defining requisite metadata to implement an approval event, an email work object schema defining requisite metadata to implement an email event, or a call work object schema defining requisite metadata to implement a call event.
Q: The one or more non-transitory computer-readable media of paragraph P, the operations further comprising: rendering, in a user interface of the virtual space and based at least in part on the work object schema associated with the communication platform, the work object as a uniform summary of the work object metadata; and unfurling, in response to receiving user input associated with the work object, the work object to display an unfurled work object, wherein the unfurled work object comprises one or more affordances associated with the work object schema associated with the communication platform.
R: The one or more non-transitory computer-readable media of paragraph O, wherein the virtual space of the communication platform is a communication channel, the operations further comprising: receiving an indication of a selection of the work object; and generating, in response to receiving the indication of the selection of the work object, a work object channel associated with the work object, wherein generating the work object channel associated with the work object comprises associating a work object identifier associated with the work object with a communication channel identifier associated with the communication channel such that the work object channel is configured to allow users of the communication platform to create, view, and interact with data associated with the work object.
S: The one or more non-transitory computer-readable media of paragraph O, the operations further comprising: generating, in response to receiving the first data representing the request to generate the work object, a recommendation indicating a likelihood that the work object is coherently associated with one or more conversations within the communication platform; and receiving, from the user profile of the user associated with the communication platform, second data representing a confirmation of the request to generate the work object.
T: The one or more non-transitory computer-readable media of paragraph O, wherein the first data representing the request to generate the work object comprises a message posted in the virtual space of the communication platform.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the one or more processors to perform operations comprising:
receiving, from a user profile of a user associated with a communication platform, first data representing a request to generate a work object in a virtual space of the communication platform;
identifying, in response to receiving the first data representing the request to generate the work object, work object metadata associated with the request to generate the work object;
determining that the work object metadata associated with the request to generate the work object satisfies a work object schema associated with the communication platform; and
generating, based at least in part on the work object metadata and the schema, the work object.

2. The system of claim 1, wherein the work object metadata associated with the request to generate the work object satisfies one of:
a task work object schema defining requisite metadata to implement a task event,
an approval work object schema defining requisite metadata to implement an approval event,
an email work object schema defining requisite metadata to implement an email event, or
a call work object schema defining requisite metadata to implement a call event.

3. The system of claim 2, the operations further comprising:
rendering, in a user interface of the virtual space and based at least in part on the work object schema associated with the communication platform, the work object as a uniform summary of the work object metadata; and
unfurling, in response to receiving user input associated with the work object, the work object to display an unfurled work object,
wherein the unfurled work object comprises one or more affordances associated with the work object schema associated with the communication platform.

4. The system of claim 1, wherein the virtual space of the communication platform is a communication channel, the operations further comprising:
generating a work object channel associated with the work object, wherein generating the work object channel associated with the work object comprises associating a work object identifier associated with the work object with a communication channel identifier associated with the communication channel such that the work object channel is configured to allow users to create, view, and interact with data associated with the work object.

5. The system of claim 4, the operations further comprising receiving an indication of a selection of the work object, wherein the work object channel is generated in response to receiving the indication of the selection of the work object.

6. The system of claim 1, the operations further comprising:
generating, in response to receiving the first data representing the request to generate the work object, a recommendation indicating a likelihood that the work object is coherently associated with one or more conversations within the communication platform; and
receiving, from the user profile of the user associated with the communication platform, second data representing a confirmation of the request to generate the work object.

7. The system of claim 1, wherein the first data representing the request to generate the work object comprises a message posted in the virtual space of the communication platform.

8. A method comprising:
receiving, from a user profile of a user associated with a communication platform, first data representing a request to generate a work object in a virtual space of the communication platform;
identifying, in response to receiving the first data representing the request to generate the work object, work object metadata associated with the request to generate the work object;
determining that the work object metadata associated with the request to generate the work object satisfies a work object schema associated with the communication platform; and
generating, based at least in part on the work object metadata and the schema, the work object.

9. The method of claim 8, wherein the work object metadata associated with the request to generate the work object satisfies one of:
a task work object schema defining requisite metadata to implement a task event,
an approval work object schema defining requisite metadata to implement an approval event,
an email work object schema defining requisite metadata to implement an email event, or
a call work object schema defining requisite metadata to implement a call event.

10. The method of claim 9, further comprising:
rendering, in a user interface of the virtual space and based at least in part on the work object schema associated with the communication platform, the work object as a uniform summary of the work object metadata; and
unfurling, in response to receiving user input associated with the work object, the work object to display an unfurled work object,
wherein the unfurled work object comprises one or more affordances associated with the work object schema associated with the communication platform.

11. The method of claim 8, wherein the virtual space of the communication platform is a communication channel, the operations further comprising:
generating a work object channel associated with the work object, wherein generating the work object channel associated with the work object comprises associating a work object identifier associated with the work object with a communication channel identifier associated with the communication channel such that the work object channel is configured to allow users of the communication platform to create, view, and interact with data associated with the work object.

12. The method of claim 11, the operations further comprising receiving an indication of a selection of the work object, wherein the work object channel associated with the work object is generated in response to receiving the indication of the selection of the work object.

13. The method of claim 8, the operations further comprising:
generating, in response to receiving the first data representing the request to generate the work object, a recommendation indicating a likelihood that the work object is coherently associated with one or more conversations within the communication platform; and
receiving, from the user profile of the user associated with the communication platform, second data representing a confirmation of the request to generate the work object.

14. The method of claim 8, wherein the first data representing the request to generate the work object comprises a message posted in the virtual space of the communication platform.

15. One or more non-transitory computer-readable media storing computer-executable instructions that, when executed by one or more processors, cause the one or more processors to perform operations comprising:
receiving, from a user profile of a user associated with a communication platform, first data representing a request to generate a work object in a virtual space of the communication platform;
identifying, in response to receiving the first data representing the request to generate the work object, work object metadata associated with the request to generate the work object;
determining that the work object metadata associated with the request to generate the work object satisfies a work object schema associated with the communication platform; and
generating, based at least in part on the work object metadata and the work object schema, the work object.

16. The one or more non-transitory computer-readable media of claim 15, wherein the work object metadata associated with the request to generate the work object satisfies one of:
a task work object schema defining requisite metadata to implement a task event,
an approval work object schema defining requisite metadata to implement an approval event,
an email work object schema defining requisite metadata to implement an email event, or
a call work object schema defining requisite metadata to implement a call event.

17. The one or more non-transitory computer-readable media of claim 16, the operations further comprising:
rendering, in a user interface of the virtual space and based at least in part on the work object schema associated with the communication platform, the work object as a uniform summary of the work object metadata; and
unfurling, in response to receiving user input associated with the work object, the work object to display an unfurled work object,
wherein the unfurled work object comprises one or more affordances associated with the work object schema associated with the communication platform.

18. The one or more non-transitory computer-readable media of claim 15, wherein the virtual space of the communication platform is a communication channel, the operations further comprising:
receiving an indication of a selection of the work object; and
generating, in response to receiving the indication of the selection of the work object, a work object channel associated with the work object,
wherein generating the work object channel associated with the work object comprises associating a work object identifier associated with the work object with a communication channel identifier associated with the communication channel such that the work object channel is configured to allow users of the communication platform to create, view, and interact with data associated with the work object.

19. The one or more non-transitory computer-readable media of claim 15, the operations further comprising:
generating, in response to receiving the first data representing the request to generate the work object, a recommendation indicating a likelihood that the work object is coherently associated with one or more conversations within the communication platform; and
receiving, from the user profile of the user associated with the communication platform, second data representing a confirmation of the request to generate the work object.

20. The one or more non-transitory computer-readable media of claim 15, wherein the first data representing the request to generate the work object comprises a message posted in the virtual space of the communication platform.
